(19) United States
(12) Patent Application Publication
(10) Pub. No.: US 2018/0154604 A1
(43) Pub. Date: Jun. 7, 2018

(54) METHOD AND APPARATUS FOR MANUFACTURING A SHAPED PAPERBOARD PRODUCT

(71) Applicant: Lappeenrannan teknillinen yliopisto, Lappeenranta (FI)

(72) Inventors: Mika KAINUSALMI, Lappeenranta (FI); Marko KASURINEN, Lappeenranta (FI); Vile LEMINEN, Lappeenranta (FI); Sami MATTHEWS, Lappeenranta (FI); Mikko RIKKONEN, Lappeenranta (FI); Jari SELESVUO, Lappeenranta (FI); Panu TANNINEN, Lappeenranta (FI); Juha TURKU, Lappeenranta (FI); Juha VARIS, Lappeenranta (FI)

(21) Appl. No.: 15/575,619

(22) PCT Filed: May 20, 2016
(86) PCT No.: PCT/FI2016/050339

§ 371 Date: Nov. 20, 2017

(30) Foreign Application Priority Data
May 21, 2015 (FI) 20155374

(51) Int. Cl. B31D 5/02

(52) U.S. Cl. CPC B31D 5/02

(57) ABSTRACT

The invention relates to a method and an apparatus for manufacturing a shaped paperboard product. According to the invention, a paperboard blank is shaped by means of a shaping tool (2) comprising a female tool element (3) and a male tool element (4), of which tool elements one is moved relative to the other tool element, and a frame tool element (5) arranged in connection with the male tool element, and the brim of the paperboard product being formed is evened by means of the frame tool element in connection with shaping. The invention also relates to the use of the apparatus.

### FIELD OF THE INVENTION

The invention relates to a method as defined in the preamble of claim 1 and to an apparatus as defined in the preamble of claim 6 for manufacturing a shaped paperboard product.

### BACKGROUND OF THE INVENTION

Different kinds of methods and shaping tools are known in the prior art for shaping paperboard products from paperboard. In the prior art there are shaping tools which have a female tool and a male tool for manufacturing a shaped paperboard product.

### OBJECTIVE OF THE INVENTION

The objective of the invention is to disclose a new type of method for manufacturing a shaped paperboard product. Another objective of the invention is to disclose a new type of apparatus for manufacturing a shaped paperboard product.

### DESCRIPTION OF THE INVENTION

The method and the apparatus according to the invention are characterized by the features set out in the claims.

The invention is based on a method for manufacturing a shaped paperboard product. In the method, a paperboard blank is shaped by means of a shaping tool which comprises a female tool element and a male tool element, of which tool elements one is moved relative to the other tool element, and a frame tool element arranged in connection with the male tool element, and the brim, e.g. the edge, of the paperboard product being formed is evened by means of the frame tool element in connection with shaping, and preferably the folding or ridging of the paperboard blank is controlled by means of the frame tool element in convection with shaping.

In addition, the invention is based on an apparatus for manufacturing a shaped paperboard product, wherein the apparatus comprises at least one shaping tool by means of which a paperboard blank is shaped, and the shaping tool comprises a female tool element and a male tool element, of which tool elements one is moved relative to the other tool element, and a frame tool element which is arranged in connection with the male tool element and which is arranged to even the brim, e.g. the edge, of the paperboard product being formed and to control the folding or ridging of the paperboard blank in connection with shaping.

In this connection, the paperboard may have been formed from any fibre-based source material, such as wood-based or plant-based source material or fibre-based composite source material or combinations thereof. The source material may be material formed from so-called fresh raw material, such as wood- or plant-based material, pulp, fibres or the like, or alternatively recycled material, such as pulp, fibres or the like, or their combinations. In one embodiment, paperboard is a paper product formed from several fibre-based plies. In one embodiment, paperboard is a thick paper product formed from one fibre-based ply or sheet-type material. Paperboard may be any paperboard, cardboard or other such thick paper which may have a grammage of 170 to 600 g/m².

In this connection, a paperboard blank means a preferably suitable-size portion, piece or the like, cut or removed from paperboard material for forming the paperboard product. Preferably, the paperboard blank is a portion of paperboard cut to a size suitable in terms of the product being formed. In one embodiment, the paperboard blank has been treated in a creasing step before shaping. In one embodiment, the paperboard blank has been cut from paperboard material, e.g. a web, before shaping. The paperboard blank may contain creases, incisions, cuts, openings or the like.

In this connection, shaping of the paperboard blank means any shaping, processing, forming or pressing to shape or their combinations for providing the shape of the paperboard product.

Preferably, the mating piece for the female tool element is the male tool element and, correspondingly, the mating piece for the male tool element is the female tool element.

In one embodiment, the female tool element is arranged above the male tool element. In one embodiment, the female tool element is arranged below the male tool element. In one embodiment, the female tool element is moved against the stationary male tool element. In one embodiment, the female tool element is moved in the down-up direction or alternatively in the up-down direction. Preferably, the female tool element is moved so as to be pressed against the male tool element to provide pressure and thereby shaping. In one embodiment, the female tool element is moved by means of at least one actuator, e.g. a hydraulic or pneumatic actuator, of the female tool element against the male tool element. In one embodiment, the shaping tool comprises at least one actuator of the female tool element for moving the female tool element. In one embodiment, the shaping tool comprises at least one actuator of the male tool element for moving the male tool element. In one embodiment, the actuator is a cylinder.

In one embodiment, the step of shaping the paperboard blank is carried out in such a way that the mouth of the paperboard product being formed opens down.

In one embodiment, the pressing force of the male tool element relative to the female tool element is controlled by means of a flexible structure of the male tool element, e.g. flexible material or springs, such as by means of disc springs, and in a preferred embodiment by varying the preloading or stiffness of the flexible structure. In one embodiment, the male tool element comprises at least one or more flexible structures, e.g. springs, such as disc springs, by means of which, e.g. by the stiffness of which, it is possible to control the pressing force of the male tool element relative to the female tool element. In one embodiment, by means of the flexible structure of the male tool element, e.g. by means of its stiffness, it is possible to control the degree to which force is used for evening the brim of the paperboard product. The distribution of force between different tool elements can advantageously be adjusted, particularly by means of the disc springs, so as to provide good quality of the paperboard product.

In one embodiment, the frame tool element is a part separate from the male tool element. In one embodiment, the frame tool element is connected to the male tool element. In one embodiment, the frame tool element is part of the male tool element. In one embodiment, the frame tool element is arranged around the male tool element. In one embodiment, the frame tool element is arranged in connection with the male tool element in such a way that the frame tool element is configured to peripherally surround the male tool element.

In one embodiment, the mating piece for the frame tool element is the female tool element.

In one embodiment, the frame tool element, specifically its movement and pressing force, is controlled by means of at least two actuators of the frame tool element, e.g. hydraulic or pneumatic actuators. In one embodiment, the frame tool element is controlled by means of at least three, alternatively at least four, actuators of the frame tool element. In one embodiment, the shaping tool comprises at least two actuators of the frame tool element. In one embodiment, the shaping tool comprises at least three actuators of the frame tool element. In one embodiment, the shaping tool comprises at least four actuators of the frame tool element. In one embodiment, the actuator is a cylinder.

In one embodiment, the path of movement of the frame tool element is adjusted mechanically by means of adjustment pieces. Thus, it is possible to control the evening of the brim of the paperboard product and its size, e.g. thickness of the edge. In one embodiment, in connection with the actuator of the frame tool element there is at least one adjustment piece. In one embodiment, the adjustment piece is arranged under the actuator. Any variations in thickness of the paperboard can advantageously be compensated for by adjusting the path of movement.

In one embodiment, the force of the shaping tool is distributed mechanically between shaping, specifically bringing-to-shape, of the paperboard product and evening of the brim. In one embodiment, the distribution of force is adjusted by varying the preloading and/or stiffness of the flexible structure of the male tool element. In one embodiment, the retaining force contributing to the folding of the paperboard is adjusted actuator-specifically. In one embodiment, the retaining force is adjusted as a function of movement of the male tool element, preferably in a preprogrammed manner.

In one embodiment, the apparatus comprises at least one control means for controlling the shaping of the paperboard product. In one embodiment, the apparatus comprises at least one control means for controlling the shaping tool. In one embodiment, the apparatus comprises at least one control means for controlling the female and/or male tool element. In one embodiment, the apparatus comprises at least one control means for controlling the frame tool element. In one embodiment, the shaping and the shaping force are controlled by the control means. In one embodiment, the operating parameters for shaping can be adjusted by the control means. In one embodiment, the operating parameters for shaping can be selected by the control means.

In one embodiment, the male tool element and the frame tool element are controlled separately. In one embodiment, the male tool element and the frame tool element are controlled as a single unit.

In one embodiment, different control operations for evening the brim of the paperboard product are performed separately, i.e. independently of one another. In one embodiment, at least two different control operations are performed as a function of one another. In one embodiment, the control operation for evening the brim of the paperboard product is performed in a stepless manner.

In one embodiment, the shaped paperboard product is lifted from the male tool element by lifting the frame tool element after the female tool element has been moved off, e.g. lifted up or lowered down from the male tool element, i.e. when the female tool element no longer contacts the male tool element. In one embodiment, the shaping tool comprises means for lifting the frame tool element, whereby the shaped paperboard product is liftable from the male tool element.

In one embodiment, the apparatus comprises at least one heating means for heating the shaping tool or part of it. In one embodiment, the apparatus comprises at least one heating means for heating the female tool element.

In one embodiment, the apparatus according to the invention is a tool module which is connectable to a modular paperboard product manufacturing line. In one embodiment, the apparatus according to the invention is part of a tool module which is connectable to a modular paperboard product manufacturing line. In one embodiment, the tool module is provided with the shaping tool. In one embodiment, the tool module is provided, in addition to the shaping tool, with one or more tools for processing the paperboard blank and/or forming the paperboard product. Preferably, the tool module provided with the apparatus according to the invention is arranged in a file with other tool modules on the modular paperboard product manufacturing line. Preferably, different tool modules are arranged in a suitable order considering the manufacture of the paperboard product. In one embodiment, the tool module is connected to the frame, e.g. to a guide, of the modular paperboard product manufacturing line. In one embodiment, the tool module provided with the apparatus according to the invention is independently replaceable on the modular paperboard product manufacturing line. In one embodiment, the apparatus according to the invention is replaceable on the paperboard product manufacturing line or manufacturing process. In one embodiment, the tool module provided with the apparatus according to the invention is moveable on the modular paperboard product manufacturing line.

In one embodiment, the method comprises a pretreatment step for processing the paperboard blank before shaping the paperboard blank.

In one embodiment, the method comprises a posttreatment step for post-treating the shaped paperboard product after the shaping step.

As the shaping tool it is possible to use any shaping tool which comprises a male tool element, a female tool element and a frame tool element. As the male tool element, the female tool element and/or the frame tool element it is possible to use components known per se in the art, or alternatively components designed specifically for the apparatus according to the invention or other suitable components.

The method and the apparatus according to the invention may be used in the manufacture of any paperboard product. In one embodiment, the paperboard product is selected from the group of trays, dishes, containers, suchlike products and different combinations thereof. The apparatus according to the invention may be used with any paperboard product manufacturing line, manufacturing equipment or manufacturing process. The apparatus according to the invention may be used on a modular paperboard product manufacturing line.

By means of the invention it is possible to improve the evenness of the brim of a paperboard product. Thus, it is possible to improve the appearance of the paperboard product and seamability of a lid added to the paperboard product. Evening the brim of the paperboard product improves adding of the lid tightly on the paperboard product and allows sealing of the paperboard product in a protective-gas-tight manner.

The apparatus according to the invention may be used as a module on a modular manufacturing line structure. Mass production of the apparatus for different manufacturing processes can be easily arranged. Thus, it is possible to reduce the manufacturing costs of the equipment. In addition, the spare parts service becomes easier and costs are reduced.

### LIST OF FIGURES

FIG. 1 illustrates one manufacturing line comprising the apparatus according to the invention, and

FIG. 2 illustrates one apparatus according to the invention.

### EXAMPLES

The invention will now be described in detail by way of an example of its embodiment with reference to the accompanying figures.

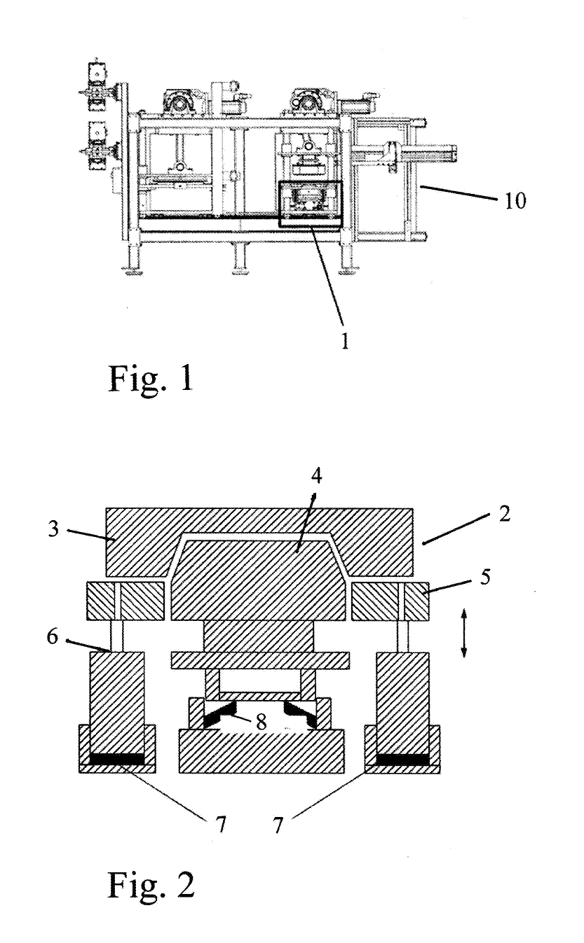

FIG. 1 illustrates a modular paperboard product manufacturing line (10) comprising an apparatus (1) according to the invention as a tool module, i.e. as a shaping module.

FIG. 2 illustrates one apparatus according to the invention for shaping a tray-type paperboard product. The apparatus of FIG. 2 comprises one shaping tool (2), by means of which a paperboard blank is shaped. The shaping tool (2) comprises a female tool element (3) and a male tool element (4). The female tool element is arranged above the male tool element and is moved relative to the male tool element. The shaping tool (2) comprises at least one actuator (not shown in the figure) of the female tool element, e.g. a pneumatic or hydraulic cylinder, for moving the female tool element (3). The female tool element (3) is moved in the down-up direction against the stationary male tool element (4), which is a mating piece for the female tool element, in such a way that the female tool element is pressed against the male tool element to provide pressure and shaping of the paperboard blank. The mouth of the paperboard product being formed opens down. The male tool element (4) comprises at least one or more disc springs (8), by means of which, e.g. by varying their stiffness, it is possible to control the pressing force of the male tool relative to the female tool element (3).

Further, the shaping tool (2) comprises a frame tool element (5) arranged in connection with the male tool element (4) to peripherally surround the male tool element. The frame tool element (5) is arranged to even the edge of the paperboard product being formed and to control the folding of the paperboard blank in connection with shaping. The mating piece for the frame tool element (5) is the female tool element (3). Further, the shaping tool (2) comprises at least two actuators (6) of the frame tool element, e.g. pneumatic or hydraulic cylinders, for controlling the movement and pressing force of the frame tool element (5). In connection with the actuator (6) of the frame tool element, such as under it, there is at least one adjustment piece (7) for mechanically adjusting the path of movement of the frame tool element (5).

The apparatus comprises at least one control means (not shown in the figure) for controlling the shaping tool (2) in such a way that the female tool element (3) can be independently controlled where desired, and the frame tool element (5) can be independently controlled relative to the male tool element (4) where desired. Different control operations for evening the brim of the paperboard product can be performed separately, i.e. independently of one another, or alternatively as a function of one another.

The shaping tool (2) may comprise means for lifting the frame tool element (5), whereby the shaped paperboard product is liftable from the male tool element (4).

Further, the apparatus comprises at least one heating means (not shown in the figure) for heating the shaping tool or part of it.

The method and the apparatus according to the invention are suitable, as various embodiments, for use in providing shaping devices for paperboard blanks of various types, and for use in connection with the manufacture of various paperboard products or the like.

The invention is not exclusively limited to the above examples, but many variations are possible within the scope of the inventive idea defined by the claims.

1. A method for manufacturing a shaped paperboard product, wherein a paperboard blank is shaped by means of a shaping tool comprising a female tool element and a male tool element, one of which tool elements is moved relative to the other tool element, and a frame tool element which is arranged in connection with the male tool element, and the brim of the paperboard product being formed is evened by means of the frame tool element in connection with shaping, the distribution of force and the pressing force of the male tool element relative to the female tool element being controlled by means of a flexible structure of the male tool element, and the frame tool element is controlled by means of at least two actuators of the frame tool element, and the path of movement of the frame tool element is adjusted mechanically by means of at least one adjustment piece which is arranged in connection with the actuator of the frame tool, and the frame tool element is controlled independently.

2. The method according to claim 1, wherein the female tool element is moved relative to the male tool element to provide pressure.

3. The method according to claim 1, wherein the flexible structure used is a disc spring.

4. The method according to claim 1, wherein the movement and pressing force of the frame tool element are controlled by means of at least two actuators of the frame tool element.

5. The method according to claim 1, wherein the adjustment piece is arranged under the actuator of the frame tool.

6. An apparatus for manufacturing a shaped paperboard product, wherein the apparatus comprises at least one shaping tool, by means of which a paperboard blank is shaped, and the shaping tool comprises a female tool element and a male tool element, of which tool elements one is moved relative to the other tool element, and a frame tool element arranged in connection with the male tool element to even the brim of the paperboard product being formed, at least two actuators of the frame tool element for controlling the frame tool element, and in connection with the actuator of the frame tool element at least one adjustment piece for mechanically adjusting the path of movement of the frame tool element, and the male tool element comprises at least one or more flexible structures, by means of which the distribution of force and the pressing force of the male tool element relative to the female tool element can be controlled, and the frame tool element is independently controllable.

7. The apparatus according to claim 6, wherein the female tool element is arranged above the male tool element and is moved relative to the male tool element.

8. The apparatus according to claim 6, wherein the shaping tool comprises at least one actuator of the female tool element for moving the female tool element.

9. The apparatus according to claim 6, wherein the male tool element comprises at least one or more disc springs, by means of which it is possible to control the pressing force of the male tool element relative to the female tool element.

10. The apparatus according to claim 6, wherein the frame tool element is arranged in connection with the male tool element in such a way that the frame tool element is configured to peripherally surround the male tool element.

11. The apparatus according to claim 6, wherein the shaping tool comprises at least two actuators of the frame tool element for controlling the movement and pressing force of the frame tool element.

12. The apparatus according to claim 6, wherein under the actuator of the frame tool element there is at least one adjustment piece for mechanically adjusting the path of movement of the frame tool element.

13. The apparatus according to claim 6, wherein the apparatus comprises at least one control means for controlling the shaping tool.

14. The apparatus according to claim 6, wherein the shaping tool comprises means for lifting the frame tool element.

15. The apparatus according to claim 6, wherein the apparatus is a tool module which is connectable to a modular paperboard product manufacturing line.

16. Use of the apparatus according to claim 6 in the manufacture of a paperboard product.
